(19) United States
(12) Patent Application Publication
(10) Pub. No.: US 2012/0008224 A1
(43) Pub. Date: Jan. 12, 2012

(54) MAGNETIC TRANSFER MASTER SUBSTRATE, MAGNETIC TRANSFER METHOD USING THE SUBSTRATE, AND MAGNETIC TRANSFER MEDIUM

(75) Inventor: Shinji UCHIDA, Matsumoto-city (JP)

(73) Assignee: Fuji Electric Device Technology Co., Ltd., Tokyo (JP)

(21) Appl. No.: 13/045,520

(22) Filed: Mar. 10, 2011

(30) Foreign Application Priority Data
Jul. 8, 2010 (JP) 2010-156104
Jan. 14, 2011 (JP) 2011-006006

(51) Int. Cl. G11B 5/86; C23F 1/00

(52) U.S. Cl. 360/16; 216/22; G9B/5.308

(57) ABSTRACT

A magnetic transfer master substrate includes a non-magnetic base having depressed portions formed on a surface thereof corresponding to an information signal array, a ferromagnetic body formed in the depressed portions and having a top portion thereof protruding above the surface of the non-magnetic base, and a non-magnetic protective film covering the surface of the non-magnetic base, except for the depressed portion thereof, and also covering a side portion of the ferromagnetic body. A section through the ferromagnetic body, taken perpendicularly to the substrate, includes a round corner, a curvature of which has a radius of no less than 1 nm and no more than 10 nm. The apex of the top portion of the ferromagnetic body protrudes above the surface of the non-magnetic base by 2 nm or more, and protrudes above the surface of the non-magnetic protective film by a distance less than the radius of the curvature.

### BACKGROUND OF THE INVENTION

1. Technical Field

The present invention relates to a magnetic recording medium. More particularly, the magnetic recording medium of the invention relates to a magnetic recording medium wherein there is no need to separately write servo information. Also, the invention includes a magnetic recording medium manufacturing method whereby servo information can be easily recorded.

2. Related Art

In a general HDD device, ahead is caused to hover around 10 nm above a magnetic recording medium, and a data read/write is carried out. Bit information on the magnetic recording medium is stored in concentrically disposed data tracks. The magnetic head is positioned above the data tracks when reading or writing data. Servo data for the positioning is recorded at constant angle intervals with respect to the data tracks on the magnetic recording medium. As it is generally often the case when the servo information is recorded using a magnetic head, a problem has occurred in that a write time has increased along with an increase in recording tracks in recent years, and the production efficiency of the HDD has dropped.

Bearing in mind this problem, a method has been proposed whereby, instead of writing the servo information using the magnetic head, the servo information is recorded en bloc on the magnetic transfer medium by means of a magnetic transfer technique, using a master substrate bearing the servo information. For example, a method is disclosed in JP-A-2002-083421 whereby, using a kind of master substrate on which a servo pattern is formed with a ferromagnetic body, the servo information of the master substrate is transferred to a perpendicular recording medium.

As the master substrate is repeatedly brought into direct contact with and separated from the magnetic disk, deformation and losses of the ferromagnetic body on the master substrate develop along with the repeated use, and a strength reduction or loss of a recording signal occurs. In order to solve this, for example, JP-A-2000-195046, Japanese Patent No. 3,343,343, and Japanese Patent No. 3,329,259 have been disclosed relating to the configuration of a master substrate.

In JP-A-2000-195046, there is disclosed a magnetic transfer master carrier that transfers recording information to a magnetic recording medium, wherein there are a plurality of transfer information recording portions, configured of a ferromagnetic body, corresponding to transfer recording information, a non-magnetic material portion that segregates the transfer information recording portions exists between adjacent transfer information recording portions, and the surfaces of the transfer information recording portions and the surface of the non-magnetic material portion essentially form the same plane. The thickness of the transfer information recording portions is 20 to 1,000 nm. Also, in the quoted JP-A-2000-195046, being essentially the same plane means that, specifically, the level difference between the portions in which there is a magnetic layer and the portions in which there is no magnetic layer is 30 nm or less, and preferably 10 nm or less.

In Japanese Patent No. 3,343,343, there is disclosed a master information carrier including depressed portions formed in positions corresponding to a magnetization pattern, wherein a ferromagnetic thin film, as well as being formed in the depressed portions, is formed in such a way that its surface protrudes from one main surface on the depressed portion side of the base, and the level difference between the surface of the ferromagnetic thin film and the one main surface of the base is 200 nm or less (excepting a case in which it is 30 nm or less).

Also, in another aspect of Japanese Patent No. 3,343,343, there is disclosed a master information carrier including the base in which the depressed portions are formed in positions corresponding to the magnetization pattern, and a ferromagnetic thin film formed in the depressed portions in such way that its surface is disposed inside the depressed portions, wherein the distance between the one main surface on the depressed portion side of the base and the surface of the ferromagnetic thin film is 100 nm or less (excepting a case in which it is 30 nm or less).

In Japanese Patent No. 3,329,259, there is disclosed a master substrate wherein, as a first configuration, a formation pattern corresponding to an information signal array is provided on the surface of a non-magnetic base by means of an array of ferromagnetic thin films deposited on the base surface, and a non-magnetic solid is packed between adjacent ferromagnetic thin films in the array of ferromagnetic thin films. Also, there is disclosed a master substrate wherein, as a second configuration, a formation pattern corresponding to an information signal array is provided by means of an array of depressed portions formed on the base surface, and a ferromagnetic thin film is packed into the depressed portions formed on the base surface. Also, it is also disclosed that, with either configuration, a hard protective film is formed on the surfaces of the ferromagnetic thin film and non-magnetic base.

Also, in JP-A-2009-295250, there is disclosed a magnetic transfer master carrier wherein a magnetic layer is formed on a side surface of the magnetic transfer master carrier, as well as on a leading edge surface of a protruding portion thereof. Furthermore, the leading edge of the protruding portion may also be chamfered in order that it connects easily with the magnetic layer extending from the side surface, easily forming a continuous magnetic film.

Also, in JP-A-2003-178440, there is disclosed a magnetic transfer master carrier wherein a protruding portion of a pattern formed on the master carrier has a spherical apex in order that, after the master carrier and a slave medium are brought into contact and a magnetic transfer is carried out, the two are easily separated from each other, and no damage is caused to the slave medium.

Year by year, pattern dimensions are being miniaturized along with an increase in recording density. For this reason, it has become necessary in recent years that a ferromagnetic pattern of a master substrate corresponding to a signal array for transferring an information signal to a magnetic recording medium is also given a pitch of 100 nm or less. In this kind of situation, with the kinds of structure of the master substrates disclosed in the heretofore known Japanese Patent No. 3,343,343 and Japanese Patent No. 3,329,259 wherein the surface of the ferromagnetic body protrudes above the surface of the non-magnetic base, it happens that, by the pattern being miniaturized, the master substrate becomes bad because of a servo defect due to a reduction of an output signal caused by a slight loss or deformation in the edge of the ferromagnetic body pattern. Also, a detachment of the ferromagnetic thin film itself accompanying the miniaturization of the pattern becomes noticeable, and the film is unable to endure the repeated use of the master substrate.

With regard to the manufacture of this kind of high recording density magnetic recording medium with a track pitch of 100 nm or less, we have found that the durability of the master substrate improves by at least one portion of the ferromagnetic body pattern being covered by the non-magnetic protective film, and the top surfaces of the non-magnetic protective film and ferromagnetic body being even. Furthermore, it has been found that the cross-sectional form of the ferromagnetic body being of a specific form is effective in preventing a reduction of the output signal due to a loss or deformation in the edge of the ferromagnetic body pattern in a master substrate with a track pitch of 100 nm or less.

### SUMMARY OF THE INVENTION

One aspect of the invention, bearing in mind the heretofore described problems, provides a magnetic transfer master substrate having a ferromagnetic body pattern corresponding to a signal array for transferring an information signal to a magnetic recording medium, the magnetic transfer master substrate including a non-magnetic base having depressed portions corresponding to the signal array in its surface, a ferromagnetic body, embedded in the depressed portions, of which one portion protrudes above the surface of the non-magnetic base, and a non-magnetic protective film that covers the surface of the non-magnetic base and at least one portion of the ferromagnetic body, wherein the radius of curvature of a corner portion of a cross-section of the portion of the ferromagnetic body protruding above the surface of the non-magnetic base when cutting perpendicularly to the substrate is 1 nm or more, 10 nm or less, the height of the portion of the ferromagnetic body protruding above the surface of the non-magnetic base is 2 nm or more, and the height from the surface of the non-magnetic protective film to the apex of the ferromagnetic body is less than the radius of curvature.

Also, one aspect of the invention relates to a manufacturing method of a magnetic transfer master substrate having a ferromagnetic body pattern corresponding to a signal array for transferring an information signal to a magnetic recording medium, the manufacturing method including (1) a step of providing a non-magnetic base, (2) a step of forming depressed portions corresponding to the signal array in the surface of the non-magnetic base, (3) a step of depositing a ferromagnetic body in the depressed portions and on the surface of the non-magnetic base in which the depressed portions are formed, (4) a step of forming the ferromagnetic pattern by etch processing the non-magnetic base and ferromagnetic body, wherein the ferromagnetic body is caused to protrude above the surface of the non-magnetic base to a height of 2 nm or more by making the etching rate of the ferromagnetic body smaller than the etching rate of the non-magnetic base, and the radius of curvature of a corner portion of a cross-section of the portion of the ferromagnetic body protruding above the surface of the non-magnetic base when cutting perpendicularly to the substrate is made 1 nm or more, 10 nm or less, and (5) a step of covering the surface of the non-magnetic base and at least one portion of the ferromagnetic body with a non-magnetic protective film, wherein the height from the surface of the non-magnetic protective film to the apex of the ferromagnetic body is less than the radius of curvature.

Furthermore, we have found that the non-magnetic protective film of the master substrate being of a hardness of 1 GPa or less is effective in increasing the durability of the master transfer without carrying out cleaning of the master substrate.

Also, one aspect of the invention relates to a magnetic transfer method, including a step of placing the master substrate and a magnetic recording medium one on top of the other and bringing the two into contact, a step of applying a magnetic field to a conjoined body configured of the master substrate and magnetic recording medium in a condition in which they are in contact, and recording a magnetization pattern corresponding to the ferromagnetic body pattern corresponding to the signal array of the master substrate on the magnetic recording medium, and a step of separating the master substrate and magnetic recording medium, and to a magnetic transfer medium.

The invention provides a master substrate, and a manufacturing method thereof, that improve durability and magnetic transfer performance in the manufacture of a high recording density magnetic recording medium, and provides a magnetic transfer method and magnetic transfer medium using the substrate and manufacturing method.

### BRIEF DESCRIPTION OF THE DRAWINGS

FIG. 1 is a sectional view of a magnetic transfer master substrate of the invention;

FIG. 2 is an enlarged view of one portion of FIG. 1;

FIGS. 3A to 3E are sectional views showing a manufacturing method of the invention; and

FIGS. 4A and 4B are sectional views showing a magnetic transfer method of the invention.

### DETAILED DESCRIPTION OF THE EMBODIMENTS

Hereafter, a description will be given of an embodiment of the invention.

Magnetic Transfer Master Substrate and Manufacturing Method Thereof

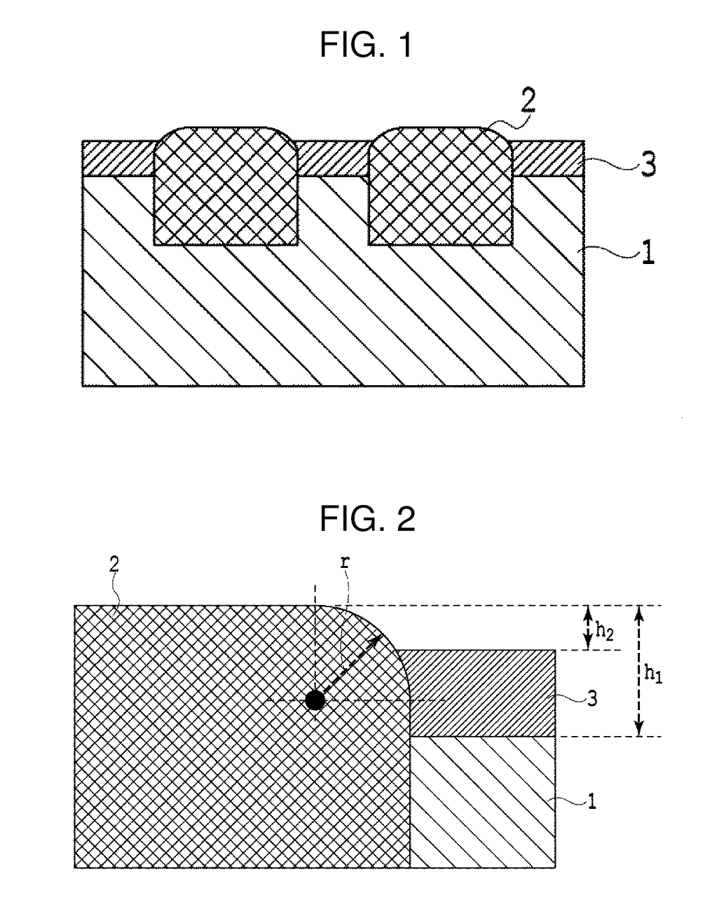

FIG. 1 is an example of a magnetic transfer master substrate of the invention, and FIG. 2 is an enlarged view thereof. The master substrate of the invention is such that depressed portions corresponding to a signal array are formed in the surface of a non-magnetic base 1, a ferromagnetic body 2 is embedded in the depressed portions in such a way that one portion thereof protrudes above the surface of the non-magnetic base 1, and furthermore, the surface of the non-magnetic base 1 and at least one portion of the ferromagnetic body 2 are covered with a non-magnetic protective film 3 (refer to FIG. 1). Specifically, the master substrate of the invention is such that a radius of curvature r of a corner portion of a cross-section of the portion of the ferromagnetic body 2 protruding above the surface of the non-magnetic base 1 when cutting perpendicularly to the substrate is 1 nm or more, 10 nm or less, a height h₁ of the portion of the ferromagnetic body 2 protruding above the surface of the non-magnetic base 1 is 2 nm or more, and furthermore, a height h₂ from the surface of the non-magnetic protective film 3 to the apex of the ferromagnetic body 2 is less than the radius of curvature r (refer to FIG. 2).

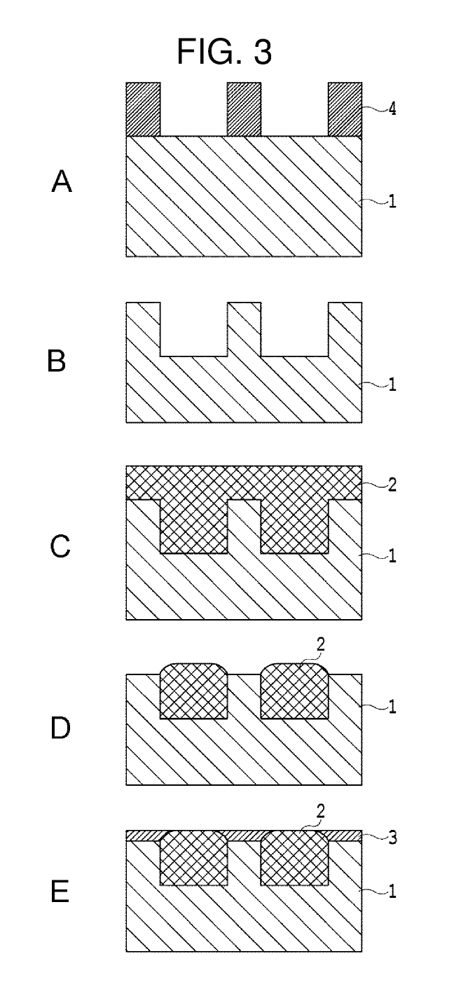

Next, a description will be given of a manufacturing method of the master substrate of the invention, using FIGS. 3A to 3E.

The invention is such that, firstly, a resist film 4 is formed on the non-magnetic base 1, and the resist film 4 is patterned in accordance with information to be transferred (FIG. 3A). Specifically, the resist film 4 is removed from places in which the ferromagnetic body 2 is to be embedded.

The non-magnetic base 1 may be the substrate itself, or may be another non-magnetic body deposited on the substrate as a pattern formation film. Owing to their non-magnetism, workability, and versatility, Si, SiO₂, Al, Al₂O₃, or a compound thereof, can be used for the non-magnetic base 1. Also, a non-magnetic metal such as Ti, Cr, or Al, carbon, Si, glass, spin on glass (SOG), or the like, can also be utilized for the pattern formation non-magnetic body film. Also, a common deposition method such as a sputtering method or a CVD method can be utilized as the deposition method.

It being sufficient that the resist film 4 has process tolerance and sufficient subsequent removal performance in a step of etching the non-magnetic base 1, it can be selected in accordance with the patterning method. The patterning of the resist film 4 may be achieved by an exposure to and subsequent development by an electron beam, or a nanoimprint lithography may be used. In the case of the exposure to and development by the electron beam, a common electron beam-use resist can be used owing to its exposure and development performance, and process tolerance and removal performance in the next etching step. In the case of the nanoimprint lithography, by pressing a stamper on which an irregular pattern is formed against the resist film 4 applied on the non-magnetic base 1, the irregular pattern of the stamper is transferred to the resist film 4. There are an optical imprint, a thermal imprint, and a room temperature imprint, depending on differences in irregularity transfer methods, and any one of them can be used. Owing to their transferability, and process tolerance and removal performance in the non-magnetic base 1 etching step, it is possible to use a polymethylmethacrylate (PMMA) resin, an acrylic light-curing resin, an SOG including an organic material, a polyimide resin, or the like, for the resist film 4 to be patterned by the nanoimprint lithography.

After the patterning of the resist film 4, the non-magnetic base 1 is etched with the pattern of the resist film 4 as a mask, after which the resist film 4 is removed, forming the irregular pattern of the non-magnetic base 1 (FIG. 3B). The processing of the non-magnetic base 1 can be carried out by various kinds of etching, such as a reactive ion etching (RIE), an ion beam etching (IBE), or a wet etching, by selecting the material of the non-magnetic base 1 and the material of the resist film 4. The removal of the resist film 4 can be also carried out with a wet method using a stripping liquid, or a dry etching such as the RIE or IBE.

Also, it is also acceptable to form in advance a second thin film (not shown), which is a mask when processing the non-magnetic base, on the surface of the non-magnetic base 1, etch the second thin film with the pattern of the resist film 4 as a mask, then process the non-magnetic base 1 with the patterned second thin film as a mask. For example, a Si substrate may be used as the non-magnetic base 1, carbon as the second thin film, and an SOG as the resist film 4. After depositing carbon as the second thin film on the Si substrate by sputtering, and forming the pattern of the SOG resist film 4 on the carbon thin film, it is possible to pattern the carbon thin film with an RIE using oxygen gas, and subsequently process the Si substrate with an RIE using CF₄ gas, with the carbon thin film as a mask.

Furthermore, the irregular pattern of the non-magnetic base 1 may also be formed without using a masking thin film such as the resist. For example, it is possible to form a non-magnetic film on the substrate, and form an irregular pattern on the film using a room temperature nanoimprint lithography or thermal imprint lithography. In view of the fact that the non-magnetic film ultimately remains on the master substrate, and needs to be of a durability that can withstand being brought into contact with and detached from a magnetic recording medium during a magnetic transfer, an SOG or polyimide resin is preferable.

After the irregular pattern is formed on the non-magnetic base 1, the ferromagnetic body 2 is deposited over the irregular pattern of the non-magnetic base 1 (FIG. 3C). The film thickness at this time, being such that the ferromagnetic body 2 fills the depressed portions in the surface of the non-magnetic base 1, and furthermore, the ferromagnetic body 2 accumulated in the depressed portions is higher than the surface of the non-magnetic base 1, is preferably 2 nm or more. Preferably, the surface of the ferromagnetic body 2 is approximately flat for the sake of convenience in a subsequent step.

It is possible to utilize Fe, Co, Cr, Ni, or an alloy including one or more thereof, as the ferromagnetic body 2. FeCo, FePt, or the like, which have a high saturation magnetization, are more preferable. It is possible to use a sputtering method, a vapor deposition method, a plating method, or the like, for the deposition of the ferromagnetic body 2.

Subsequently, the non-magnetic base 1 and ferromagnetic body 2 are processed, forming a ferromagnetic body pattern (FIG. 3D).

In the master substrate of the invention, it is preferable from the point of view of the durability of the master substrate that the radius of curvature r of the corner portion of the cross-section of the portion of the ferromagnetic body 2 protruding above the surface of the non-magnetic base 1 when cutting perpendicularly to the substrate is 1 nm or more. When the radius of curvature r of the corner portion is less than 1 nm, the durability decreases, and a partial loss of servo signals, or a portion with low signal strength, is liable to occur.

Furthermore, it is preferable from the point of view of the signal characteristics of a magnetic recording medium to which a magnetic transfer is made that the radius of curvature r of the corner portion is 10 nm or less. When the radius of curvature is more than 10 nm, noise occurs in the servo signal in a drive evaluation. It is thought that this is because a magnetic flux concentration at the edge portion of the ferromagnetic body pattern at a time of a magnetic transfer is not possible, and this becomes a source of noise.

Also, it is preferable that the height h₁ of the portion of the ferromagnetic body 2 protruding above the surface of the non-magnetic base 1 is 2 nm or more. When the height h₁ is less than 2 nm, it may happen that a portion in which the signal strength is low appears in the servo signal in the drive evaluation of the high density magnetic recording medium. It is thought that this is because it is not possible to obtain an amount of magnetization sufficient to reverse the magnetization of the transfer medium in some portion of the ferromagnetic body pattern when h₁ is less than 2 nm.

The processing of the non-magnetic base 1 and ferromagnetic body 2 can be carried out by a dry etching, wet etching, or chemical mechanical polishing (CMP). Specifically, materials and/or etching conditions wherein the etching rate of the non-magnetic base 1 is higher than the etching rate of the ferromagnetic body 2 are selected. By choosing these kinds of material and/or etching conditions, the processing amount of the non-magnetic base 1 is greater than the processing amount of the ferromagnetic body 2, and it is possible to fabricate a master substrate of a shape such that the ferromagnetic body 2 protrudes from the non-magnetic base 1.

Furthermore, in order to smoothen the corner portion of the portion of the ferromagnetic body 2 protruding from the non-magnetic base 1, and control the radius of curvature r of the corner portion, it is possible to use the following kind of method.

In a dry etching using a reactive ion etching (RIE), the smaller the ratio of the RF power to the substrate bias is made, the larger the radius of curvature becomes. For example, the ratio of the RF power to the substrate bias is 1 to 50. Preferably, it is 1 to 20. From the point of view of the controllability of the etching amount and radius of curvature of the corner portion, and of magnetic characteristic damage to the ferromagnetic body 2, it is preferable that the RF power is 10 to 1,500 W, and it is preferable that the substrate bias is 5 to 800 W.

Also, in a range in which the etching rate of the ferromagnetic body 2 is smaller than that of the non-magnetic base 1, the bigger the gas type selected makes the etching rate of the ferromagnetic body 2, the larger it is possible to make the radius of curvature r. For example, the ratio of the etching rate of the non-magnetic base 1 to the etching rate of the ferromagnetic body 2 may be 1 to 50, and is preferably 2 to 5. For example, when the non-magnetic base 1 is of a carbon-based material, and the ferromagnetic body 2 is an FeCo alloy, the etching rate of the carbon-based material is reduced by reducing the proportion of O₂ gas in a mixed gas of Ar and O₂, within a range in which the etching rate of the FeCo alloy is smaller than the etching rate of the carbon-based material. As a result of this, the ratio of the etching rate of the FeCo alloy with respect to that of the carbon-based material increases, and the radius of curvature r becomes larger. In the same way, when the non-magnetic base 1 is of a Si-based material, and the ferromagnetic body 2 is a FeCo alloy, the ratio of the etching rate of the FeCo alloy with respect to that of the Si-based material increases, and the radius of curvature r becomes larger, by reducing the CF₄ content of the etching gas.

Furthermore, the lower the degree of vacuum when etching, the larger it is possible to make the radius of curvature r. From the point of view of controlling the radius of curvature r and of the stability of the RF plasma, a degree of vacuum of 0.05 to 10 Pa is preferable.

Meanwhile, in the case of a wet etching using a chemical mechanical polishing (CMP), in a range in which the etching rate of the ferromagnetic body 2 is small with respect to that of the non-magnetic base 1, the bigger the slurry agent selected makes the etching rate of the ferromagnetic body 2, the larger it is possible to make the radius of curvature r. For example, when the non-magnetic base 1 is of a carbon-based material, and the ferromagnetic body 2 is an FeCo alloy, the ratio of the etching rate of the FeCo alloy is increased with respect to that of the carbon-based material by reducing the pressing pressure of the polishing pad when polishing, or making the abrasive grains of the slurry finer, and it is possible to make the radius of curvature r of the corner portion of the ferromagnetic body larger.

Also, when the non-magnetic base 1 is of a carbon-based material, and the ferromagnetic body 2 is an FeCo alloy, the ratio of the etching rate of the FeCo alloy is increased with respect to that of the carbon-based material by making the pH of the slurry less than 8, and it is possible to make the radius of curvature r larger.

Whatever the method, a case in which the etching rate of the non-magnetic base 1 is lower than the etching rate of the ferromagnetic body 2 is not desirable, as the surface of the ferromagnetic body 2 takes on a form wherein it is lower than the surface of the non-magnetic base 1.

Next, the non-magnetic protective film 3 is formed in such a way as to cover the surface of the non-magnetic base 1 and at least one portion of the ferromagnetic body 2 (FIG. 3E). With the non-magnetic protective film 3, the height h₂ from the surface of the non-magnetic protective film 3 to the apex of the ferromagnetic body 2 is less than the radius of curvature r of the ferromagnetic body 2, and preferably, the height h₂ is 0. When h₂ is greater than r, the durability decreases, and a partial loss of servo signals, or a portion with low signal strength, is liable to occur. Meanwhile, a case in which h₂ is greater than h₁, that is, a case in which the surface of the non-magnetic protective film 3 is higher than the surface of the ferromagnetic body 2, is not desirable because a space occurs between the ferromagnetic body 2 and magnetic transfer medium at the time of the magnetic transfer step.

A polyimide, an SOG, carbon, Al, Al₂O₃, Si, SiO₂, or a compound thereof, may be used for the non-magnetic protective film 3 of the invention. Using an SOG or polyimide with a hardness of 1 GPa or less as the non-magnetic protective film 3 is preferred because, even when microscopic particles become mixed in during the magnetic transfer, the particles are trapped in the non-magnetic protective film 3, and the adherence between the surfaces of the master substrate and magnetic recording medium is not inhibited. When the hardness is higher than 1 GPa, it is not possible to maintain the adherence between the surfaces of the master substrate and magnetic recording medium due to the mixing in of the microscopic particles, and there appears a portion in which the signal strength of the magnetic transfer medium servo signal decreases. Furthermore, when an unreasonable pressure is applied between the master substrate and magnetic recording medium in a condition in which microscopic particles are mixed in, the master substrate and magnetic recording medium are scratched, and furthermore, the particles increase, and there appear additional portions in which the signal strength of the magnetic transfer medium servo signal decreases.

For the formation of the non-magnetic protective film 3, it is possible to use a method well known to those skilled in the art, provided that the method is such as may form the heretofore described form. For example, the formation of the non-magnetic protective film 3 of the invention may be carried out using a spin coating method. It is possible to use an SOG or polyimide as the non-magnetic protective film 3 formed using the spin coating method.

Also, the non-magnetic protective film 3 of the invention may be formed by covering the whole of the ferromagnetic body 2 with a non-magnetic body, and exposing the ferromagnetic body 2 by light etching the whole. The light etching can also be carried out with an RIE or IBE using oxygen gas, or by applying an organic solvent such as cyclohexanone by spin coating.

Magnetic Transfer Method

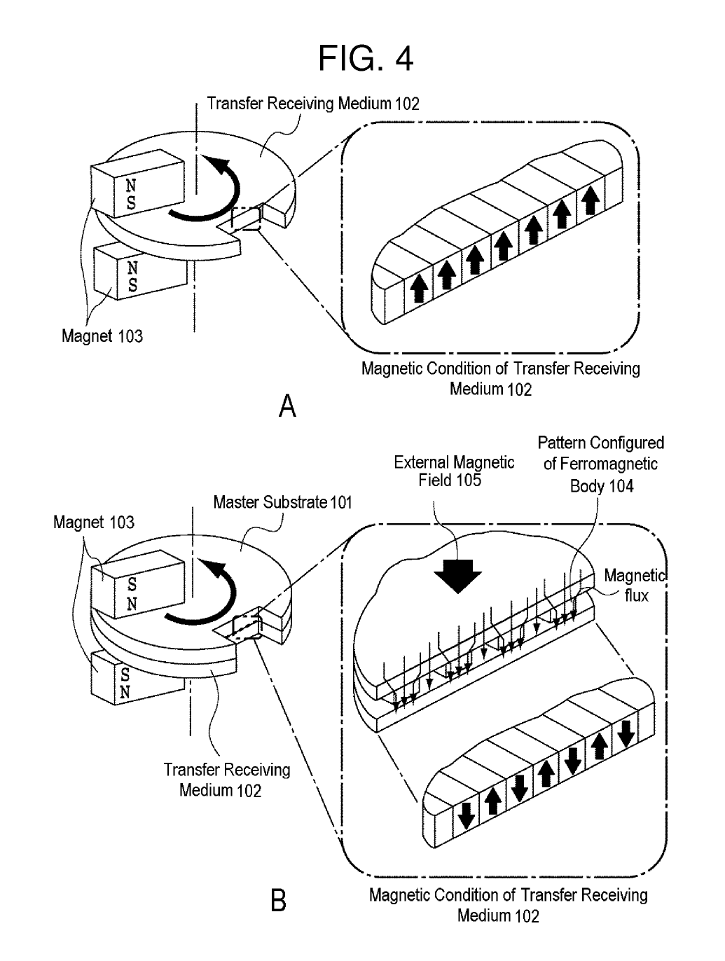

Next, a magnetic transfer method using the magnetic transfer master substrate obtained in the way heretofore described is shown in FIGS. 4A and 4B.

A magnetic transfer master substrate 101, a transfer receiving medium 102, and magnets 103 are prepared.

Firstly, a first external magnetic field is applied in an approximately perpendicular direction to the surface of the transfer receiving medium, magnetizing the transfer receiving medium 102 in one direction, as shown in FIG. 4A.

Subsequently, the transfer master substrate 101 and transfer receiving medium 102 are brought into contact, and an external magnetic field 105 of an orientation the reverse that of the first magnetic field is applied in a direction approximately perpendicular to the recording surface of the transfer receiving medium, as in FIG. 4B. A pattern 104 configured of the ferromagnetic body being provided on the transfer master substrate 101, only a little magnetic flux passes through a portion in which the ferromagnetic body pattern formed on the master substrate 101 does not exist, and the orientation of the magnetization by the first magnetic field remains. As a large amount of magnetic flux passes through a portion in which the ferromagnetic body pattern exists, it is magnetized in the orientation of the second magnetic field 105. As a result, a magnetization pattern corresponding to the irregularities formed on the surface of the master substrate is transferred. When the external magnetic field is applied, transfer may be carried out by the magnets 103 being disposed above and below the master substrate 101 and transfer receiving medium 102, and each of them rotating simultaneously, as in FIG. 4B.

Even in the event that the magnetic recording medium on which the magnetization pattern is recorded in the way heretofore described is one to which a transfer has been repeatedly made using a master substrate with a track pattern smaller than 100 nm, it is possible to have a sufficient servo signal strength, with no signal loss.

### EXAMPLES

### Example 1

Master Substrate Fabrication

The magnetic transfer master substrate of the invention is fabricated using the configuration shown in FIG. 1.

Firstly, a Si substrate of outer diameter 65 mm, inner diameter 20 mm, and thickness 0.635 mm is prepared, and a carbon film is deposited to a thickness of 80 nm using a sputtering method. The carbon film is pattern-processed in a subsequent step, becoming one portion of the non-magnetic base.

Next, an SOG resist is applied to a thickness of 70 nm using a spin coating method. A commercially available Tokyo Ohka Kogyo Co., Ltd. OCNL505 is used as the SOG.

Subsequently, an imprinting is carried out using a Ni stamper on which is formed a pattern corresponding to information to be transferred, forming an irregular pattern corresponding to the transfer pattern on the surface of the SOG. The pattern forming imprinting is carried out by superimposing the Ni stamper on the resist surface of the substrate, carrying out a 100 MPa pressurization at a room temperature condition for one minute, then removing the stamper. The pattern formed here corresponds to a track pitch of 60 nm.

As residual film exists in the pattern formed on the resist film by the imprinting, a residual film removal step is performed after the imprinting step. The SOG residual film is of 20 to 40 nm. The residual film removal is performed with an RIE using CF₄ gas.

After the SOG residual film removal, the carbon film is etched with the irregular pattern formed on the SOG as a mask, forming an irregular pattern on the carbon film. The etching of the carbon film is performed with an RIE using O₂ gas. The processing depth is 80 nm, the same as the film thickness.

Subsequently, the SOG used as the mask is removed. The SOG removal is performed with an RIE using CF₄ gas. By the procedure thus far, the irregular pattern of the non-magnetic base 1 is formed.

Next, FeCo (Co approximately 30%) is deposited as the ferromagnetic body 2, using a sputtering method, so that the thickness of a portion including a depressed portion of the non-magnetic base 1 is 200 nm, and the thickness of a portion not including a depressed portion is approximately 120 nm.

Subsequently, an etching is carried out with an RIE. The RIE processing is carried out for 252 seconds under conditions of RF power 100 W, substrate bias 20 W, 10% O₂ gas mixed with Ar gas, and degree of vacuum 0.1 Pa. Under these conditions, the etching rates separately measured in advance are 1.0 nm per second for the carbon film with respect to 0.5 nm per second for the FeCo.

A cross-sectional form of the master substrate fabricated in this way, when confirmed with a transmission electron microscope (TEM), is of a structure wherein the thickness of the ferromagnetic body 2 embedded in the depressed portions of the non-magnetic base 1 is 68 nm, the height h₁ of the ferromagnetic body 2 protruding above the surface of the non-magnetic base 1 is 6 nm, and the radius of curvature r of a corner portion of the cross-section of the protruding ferromagnetic body 2 when cutting perpendicularly to the substrate is 4 nm.

Next, the non-magnetic protective film 3 is formed in such a way as to cover the non-magnetic base 1 and one portion of the ferromagnetic body 2. Firstly, an SOG (Tokyo Ohka Kogyo Co., Ltd. OCNL505) is applied using a spin coating method to the surface of the substrate on which the ferromagnetic body pattern is formed, forming the non-magnetic protective film 3. The thickness of the non-magnetic protective film 3 is 8 nm from the surface of the non-magnetic base 1. Subsequently, a light etching is carried out with an RIE processing using CF₄ gas, removing 2 nm from the surface of the SOG non-magnetic protective film 3.

A cross-sectional form of the master substrate fabricated in this way, when confirmed with a TEM, is of a structure wherein the thickness of the ferromagnetic body 2 embedded in the depressed portions of the non-magnetic base 1 is 68 nm, the height h₁ of the ferromagnetic body 2 protruding above the surface of the non-magnetic base 1 is 6 nm, the radius of curvature r of a corner portion of the cross-section of the protruding ferromagnetic body 2 when cutting perpendicularly to the substrate is 4 nm, and furthermore, the thickness of the non-magnetic protective film 3 from the surface of the non-magnetic base 1 is 6 nm, and the height h₂ of the portion of the ferromagnetic body 2 protruding above the non-magnetic protective film 3 is 0. That is, the corner portion of the ferromagnetic body 2 is covered with the non-magnetic protective film 3, and the upper surfaces of the non-magnetic protective film 3 and ferromagnetic body 2 are of an approximately even structure.

### Example 2

Fabrication of Samples Having Various Cross-Sectional Forms

Various master substrates are fabricated, changing only the RIE conditions in the Example 1. In the example, by adopting RIE conditions of RIE power 100 to 200 W, substrate bias 10 to 50 W, O₂ gas flow rate with respect to Ar gas 100 10 to 50, degree of vacuum 0.1 to 1.5 Pa, and processing time 100 to 400 seconds, various kinds of master substrate are fabricated wherein the height of the ferromagnetic body material protruding above the surface of the non-magnetic base is 1.0 to 16.0 nm, and the radius of curvature of the corner portion of the protruding ferromagnetic body is 1.0 to 15.0 nm.

Subsequently, the non-magnetic protective film 3 is formed on each sample, using a fabricating method the equivalent of that in the Example 1. The amount of SOG dilution and spin coating number of rotations are adjusted in accordance with the height h₁ of the ferromagnetic body 2, and an application of the SOG is carried out in such a way that the SOG is 2 nm thicker than h₁. The results are shown in Tables 1 and 2. In Table 1, an RIE is carried out in such a way that h₂ is 0. Also, in Table 2, the RIE operating time is adjusted, and samples wherein h₂ is changed are fabricated.

### Example 3

Magnetic Transfer Test

A magnetic transfer of servo information to the magnetic recording medium is carried out using the master substrates fabricated in Examples 1 and 2. Furthermore, in order to investigate the repetition durability of the master substrate during the magnetic transfer, the magnetic transfer is carried out repeatedly while replacing the transfer receiving medium. During the repetition, cleaning of the surface is carried out by wiping the surface of the master substrate with a tape every 1,000 times.

Servo Characteristic Evaluation

An evaluation of the servo characteristics on the magnetic recording media onto which the magnetic transfer is carried out using the heretofore described method is carried out for the first, fifty thousandth, and one hundred thousandth magnetic recording media among the repetitions.

For the evaluation of the servo characteristics, a drive test is carried out using an evaluation drive. An evaluation of the possibility of servo following and reproduction signal output is carried out, and a determination is carried out based on the following evaluation standards. A signal output in a signal on portion five times or more that in a signal off portion being required as a servo specification, for the following standards, ◯ represents a pass, while Δ and × represent failures.

◯: Servo following is possible, and the signal output in the signal on portion is five times or more that in the signal off portion

Δ: Servo following is possible, but the signal output in the signal on portion is less than five times that in the signal off portion

×: Servo following is not possible

The results are shown in Table 1 and 2.

TABLE 1
Table 1. Form of various samples and servo characteristic evaluation results

| | Cross-sectional Form | | | |
|---|---|---|---|---|
| | Height h₁ of | Radius of Curvature r of | | Height h₂ of |
| | Ferromagnetic Body | Corner Portion of | Presence of | Ferromagnetic Body |
| Condition | Protruding Above Surface | Ferromagnetic Body | Non-magnetic | Protruding Above |
| Sample | of Non-magnetic Base | Protruding Above | Protective | Non-magnetic |
| Number | (nm) | Non-magnetic Base (nm) | Film | Protective Film (nm) |
| 1-2 | 2.0 | 0.5 | Yes | 0.0 |
| 1-2′ | | | No | — |
| 1-3 | 2.5 | 1.0 | Yes | 0.0 |
| 1-3′ | | | No | — |
| 1-4 | 3.5 | 1.5 | Yes | 0.0 |
| 1-4′ | | | No | — |
| 1-5 | 5.5 | 2.0 | Yes | 0.0 |
| 1-5′ | | | No | — |
| 1-1 | 6.0 | 4.0 | Yes | 0.0 |
| 1-1′ | | | No | — |
| 1-6 | 9.0 | 3.5 | Yes | 0.0 |
| 1-6′ | | | No | — |
| 1-7 | 12.5 | 5.0 | Yes | 0.0 |
| 1-7′ | | | No | — |
| 1-8 | 16.0 | 6.0 | Yes | 0.0 |
| 1-8′ | | | No | — |
| 1-9 | 24.0 | 9.5 | Yes | 0.0 |
| 1-9′ | | | No | — |
| 1-10 | 1.0 | 1.5 | Yes | 0.0 |
| 1-11 | 1.5 | 2.0 | Yes | 0.0 |
| 1-12 | 2.0 | 3.5 | Yes | 0.0 |
| 1-13 | 3.5 | 4.5 | Yes | 0.0 |
| 1-14 | 6.0 | 9.0 | Yes | 0.0 |
| 1-15 | 8.5 | 11.0 | Yes | 0.0 |
| 1-16 | 10.5 | 15.0 | Yes | 0.0 |

| | Evaluation Result | | | |
|---|---|---|---|---|
| | | Magnetic Recording | Magnetic Recording | |
| | Magnetic Recording | Medium Servo | Medium Servo | |
| Condition | Medium Servo | Characteristics: | Characteristics: | Remarks |
| Sample | Characteristics: | After Fifty | After One Hundred | Overall |
| Number | After First Transfer | Thousandth Transfer | Thousandth Transfer | Judgment |
| 1-2 | ◯ | ◯ | Δ | Fail |
| 1-2′ | ◯ | X | X | Fail |
| 1-3 | ◯ | ◯ | ◯ | Pass |
| 1-3′ | ◯ | Δ | X | Fail |
| 1-4 | ◯ | ◯ | ◯ | Pass |
| 1-4′ | ◯ | ◯ | Δ | Fail |
| 1-5 | ◯ | ◯ | ◯ | Pass |
| 1-5′ | ◯ | ◯ | ◯ | Pass |
| 1-1 | ◯ | ◯ | ◯ | Pass |
| 1-1′ | ◯ | ◯ | ◯ | Pass |
| 1-6 | ◯ | ◯ | ◯ | Pass |
| 1-6′ | ◯ | ◯ | ◯ | Pass |
| 1-7 | ◯ | ◯ | ◯ | Pass |
| 1-7′ | ◯ | ◯ | ◯ | Pass |
| 1-8 | ◯ | ◯ | ◯ | Pass |
| 1-8′ | ◯ | ◯ | Δ | Fail |
| 1-9 | ◯ | ◯ | ◯ | Pass |
| 1-9′ | ◯ | Δ | X | Fail |
| 1-10 | Δ | Δ | Δ | Fail |
| 1-11 | Δ | Δ | Δ | Fail |
| 1-12 | ◯ | ◯ | ◯ | Pass |
| 1-13 | ◯ | ◯ | ◯ | Pass |
| 1-14 | ◯ | ◯ | ◯ | Pass |
| 1-15 | Δ | Δ | Δ | Fail |
| 1-16 | Δ | Δ | Δ | Fail |

According to the results in Table 1, with regard to samples wherein h₁ is 2 nm or more and r is 1 nm or more, 10 nm or less, and furthermore, the surface of the non-magnetic base 1 and at least one portion of the ferromagnetic body 2 are covered with the non-magnetic protective film 3, and h₂ is 0, as with samples 1-1, 1-3 to 1-8, and 1-12 to 1-14, it is possible to obtain a magnetic transfer medium that maintains good servo characteristics even after the magnetic transfer is repeated 100,000 times.

As opposed to this, with samples wherein h₁ is less than 2 nm, as with samples 1-10 and 1-11, servo following is possible, but the signal output in the signal on portion is less than five times that in the signal off portion from the first magnetic transfer, resulting in the servo characteristics failure. When the servo portions of these transfer receiving media are checked with a magnetic force microscope (MFM), some of each magnetic pattern showed weak magnetic force. Because of this, it is thought that the reason for the signal output being less than five times is that a place where the contact with the transfer receiving medium is low occurs in some of the ferromagnetic body pattern, and sufficient magnetization is not carried out.

Also, with samples wherein r is larger than 10 nm, as with samples 1-15 and 1-16, the signal output in the signal on portion is less than five times that in the signal off portion from the first magnetic transfer, resulting in the servo characteristics failure. When the servo portions of these transfer receiving media are checked with an MFM, the edges of each magnetic pattern are unclear. Because of this, it is thought that the reason for the signal output being less than five times is that the magnetic force of the edge portions of the magnetic pattern becomes weak due to the curvature of the corner portion of the ferromagnetic body being too large.

Also, with samples wherein h₁ is greater than 15 nm, as with samples 1-8′ and 1-9′, with regard to samples that do not have the non-magnetic protective film 3, the servo characteristics of the first magnetic transfer pass, but the servo characteristics of the fifty thousandth and one hundred thousandth magnetic transfers fail. When the servo portions of these transfer receiving media are checked with an MFM, there are portions of weak magnetic force in some portion in individual magnetic pattern. Because of this, it is thought that the reason for the signal output being less than five times is that a defect occurs in some portion of the ferromagnetic body pattern of the master substrate during repeated use, and a loss of transfer to the transfer receiving medium occurs in the defect portion of the pattern.

As opposed to this, even with samples wherein h₁ is greater than 15 nm, as with samples 1-8 and 1-9, with samples on which the non-magnetic protective film 3 is formed, even the servo characteristics of the one hundred thousandth magnetic transfer pass. It is thought that this is because a defect of the ferromagnetic body pattern is curbed by the non-magnetic protective film 3.

Also, with samples wherein r is less than 2 nm and there is no non-magnetic protective film 3, as with samples 1-2′, 1-3′, and 1-4′, there is seen to be a decrease in the servo characteristics of the fifty thousandth and one hundred thousandth magnetic transfers with respect to the servo characteristics of the first magnetic transfer, resulting in failure. When the servo portions of these transfer receiving media are checked with an MFM, there are portions of weak magnetic force in some portion in individual magnetic pattern. Because of this, it is thought that the reason for the signal output being less than five times is that a defect occurs in some portion of the ferromagnetic body pattern of the master substrate during repeated use, and a defect of transfer to the transfer receiving medium occurs in the defect portion of the pattern.

As opposed to this, with samples wherein, although r is less than 2 nm, the non-magnetic protective film 3 is formed, as with samples 1-3 and 1-4, even the servo characteristics of the one hundred thousandth magnetic transfer pass. It is thought that this is because a defect of the ferromagnetic body pattern is curbed by the non-magnetic protective film 3.

However, with sample 1-2, the servo characteristics of the one hundred thousandth magnetic transfer fail.

When the servo portions of the transfer receiving media of the one hundred thousandth magnetic transfer of samples 1-2, which are samples that have the non-magnetic protective film 3 but failed, are checked with an MFM, there are portions of weak magnetic force in some portion in individual magnetic pattern. Furthermore, when the surface of the sample 1-2 is observed with an atomic force microscope (AFM), a defect is observed in one portion of the embedded ferromagnetic body pattern. Because of this, it is thought that with samples wherein r is less than 1 nm, a loss occurs in the defect portion of the ferromagnetic body pattern of the master substrate due to repeated use.

The results when changing h₂ in samples 1-8 and 1-4 are shown in Table 2.

TABLE 2
Table 2. Form of various samples and servo characteristic evaluation results

| | Cross-sectional Form | | | |
|---|---|---|---|---|
| | Height h₁ of | Radius of Curvature r of | | Height h₂ of |
| | Ferromagnetic Body | Corner Portion of | Presence of | Ferromagnetic Body |
| Condition | Protruding Above Surface | Ferromagnetic Body | Non-magnetic | Protruding Above |
| Sample | of Non-magnetic Base | Protruding Above | Protective | Non-magnetic |
| Number | (nm) | Non-magnetic Base (nm) | Film | Protective Film (nm) |
| 1-8 | 16.0 | 6.0 | Yes | 0.0 |
| 1-8-1 | 16.0 | 6.0 | Yes | 3.0 |
| 1-8-2 | 16.0 | 6.0 | Yes | 5.0 |
| 1-8-3 | 16.0 | 6.0 | Yes | 8.0 |
| 1-8-4 | 16.0 | 6.0 | Yes | 12.0 |
| 1-4 | 3.5 | 1.5 | Yes | 0.0 |
| 1-4-1 | 3.5 | 1.5 | Yes | 1.0 |
| 1-4-2 | 3.5 | 1.5 | Yes | 2.0 |
| 1-4-3 | 3.5 | 1.5 | Yes | 3.0 |

| | Evaluation Result | | | |
|---|---|---|---|---|
| | | Magnetic Recording | Magnetic Recording | |
| | Magnetic Recording | Medium Servo | Medium Servo | |
| Condition | Medium Servo | Characteristics: | Characteristics: | Remarks |
| Sample | Characteristics: | After Fifty | After One Hundred | Overall |
| Number | After First Transfer | Thousandth Transfer | Thousandth Transfer | Judgment |
| 1-8 | ◯ | ◯ | ◯ | Pass |
| 1-8-1 | ◯ | ◯ | ◯ | Pass |
| 1-8-2 | ◯ | ◯ | ◯ | Pass |
| 1-8-3 | ◯ | ◯ | Δ | Fail |
| 1-8-4 | ◯ | Δ | X | Fail |
| 1-4 | ◯ | ◯ | ◯ | Pass |
| 1-4-1 | ◯ | ◯ | ◯ | Pass |
| 1-4-2 | ◯ | ◯ | Δ | Fail |
| 1-4-3 | ◯ | Δ | X | Fail |

In the case of sample 1-8 wherein r is 6.0 nm, with samples 1-8-1 and 1-8-2, wherein h₂ is made 3.0 nm and 5.0 nm respectively, even the servo characteristics of the one hundred thousandth magnetic transfer pass. However, with samples 1-8-3 (h₂=8.0 nm) and 1-8-4 (h₂=12.0 nm), wherein h₂ is made higher still, there is a decrease in the servo characteristics during repeated use, and the servo characteristics of the fifty thousandth and one hundred thousandth magnetic transfers fail.

Also, in the same way, in the case of sample 1-4 wherein r is 1.5 nm, with sample 1-4-1, wherein h₂ is made 1.0 nm, even the servo characteristics of the one hundred thousandth magnetic transfer pass. However, with samples 1-4-2 (h₂=2.0 nm) and 1-4-3 (h₂=3.0 nm), wherein h₂ is made higher still, there is a decrease in the servo characteristics during repeated use, and the servo characteristics of the fifty thousandth and one hundred thousandth magnetic transfers fail.

When the servo portions of these failed transfer receiving media are checked with an MFM, portions of weak magnetic force are confirmed in some portion. Because of this, it is thought that with these samples, wherein h₂ is greater than r, a loss occurs in the ferromagnetic body pattern of the master substrate during repeated use.

### Example 4

Next, the effect of the track pitch on the durability will be shown.

Samples with track pitches of 45, 100, 125, and 200 are fabricated and evaluated with a fabrication method and measurement and evaluation conditions equivalent to those in Examples 1 to 3. The results are shown in Table 3. Also, the samples 1-2, 1-11, and 1-15 in Examples 1 to 3 are shown as a comparison.

TABLE 3
Table 3. Servo Characteristic Evaluation Results for Each Kind of Sample

| | | Cross-sectional Form | | |
|---|---|---|---|---|
| | | Height h₁ of | | |
| | | Ferromagnetic | Radius of Curvature r | Height h₂ of |
| | | Body Protruding | of Corner Portion of | Ferromagnetic Body |
| Condition | Pattern | Above Surface | Ferromagnetic Body | Protruding Above |
| Sample | Track Pitch | of Non-magnetic | Protruding Above | Non-magnetic |
| Number | (nm) | Base (nm) | Non-magnetic Base (nm) | Protective Film (nm) |
| 2-1 | 45 | 2.0 | 0.5 | 0.0 |
| 1-2 | 60 | 2.0 | 0.5 | 0.0 |
| 2-2 | 100 | 2.0 | 0.5 | 0.0 |
| 2-3 | 125 | 2.0 | 0.5 | 0.0 |
| 2-4 | 200 | 2.0 | 0.5 | 0.0 |
| 2-5 | 45 | 1.5 | 2.0 | 0.0 |
| 1-11 | 60 | 1.5 | 2.0 | 0.0 |
| 2-6 | 100 | 1.5 | 2.0 | 0.0 |
| 2-7 | 125 | 1.5 | 2.0 | 0.0 |
| 2-8 | 200 | 1.5 | 2.0 | 0.0 |
| 2-9 | 45 | 8.5 | 11.0 | 0.0 |
| 1-15 | 60 | 8.5 | 11.0 | 0.0 |
| 2-10 | 100 | 8.5 | 11.0 | 0.0 |
| 2-11 | 125 | 8.5 | 11.0 | 0.0 |
| 2-12 | 200 | 8.5 | 11.0 | 0.0 |
| 2-13 | 45 | 3.5 | 1.5 | 1.0 |
| 2-14 | 45 | 8.5 | 6.0 | 2.0 |
| 2-15 | 100 | 3.5 | 1.5 | 1.0 |
| 2-16 | 100 | 8.5 | 6.0 | 2.0 |

| | Evaluation Result | | | |
|---|---|---|---|---|
| | | Magnetic Recording | Magnetic Recording | |
| | Magnetic Recording | Medium Servo | Medium Servo | |
| Condition | Medium Servo | Characteristics: | Characteristics: | Remarks |
| Sample | Characteristics: | After Fifty | After One Hundred | Overall |
| Number | After First Transfer | Thousandth Transfer | Thousandth Transfer | Judgment |
| 2-1 | ◯ | Δ | Δ | Fail |
| 1-2 | ◯ | ◯ | Δ | Fail |
| 2-2 | ◯ | ◯ | Δ | Fail |
| 2-3 | ◯ | ◯ | ◯ | Pass |
| 2-4 | ◯ | ◯ | ◯ | Pass |
| 2-5 | Δ | Δ | Δ | Fail |
| 1-11 | Δ | Δ | Δ | Fail |
| 2-6 | Δ | Δ | Δ | Fail |
| 2-7 | ◯ | ◯ | ◯ | Pass |
| 2-8 | ◯ | ◯ | ◯ | Pass |
| 2-9 | X | X | X | Fail |
| 1-15 | Δ | Δ | Δ | Fail |
| 2-10 | Δ | Δ | Δ | Fail |
| 2-11 | ◯ | ◯ | ◯ | Pass |
| 2-12 | ◯ | ◯ | ◯ | Pass |
| 2-13 | ◯ | ◯ | ◯ | Pass |
| 2-14 | ◯ | ◯ | ◯ | Pass |
| 2-15 | ◯ | ◯ | ◯ | Pass |
| 2-16 | ◯ | ◯ | ◯ | Pass |

According to the results in Table 3, when the track pitch is 125 nm or more, the servo characteristics pass as far as the one hundred thousandth magnetic recording medium in every case, but when the track pitch is 100 nm or less, the servo characteristics fail unless r is 1 nm or more, 10 nm or less, in a cross-section of the ferromagnetic body 2 and non-magnetic protective film 3 when cutting perpendicularly to the substrate, h₁ is 2 nm or more, and h₂ is less than r.

When the track pitch is more than 125 nm, as with samples 2-3 and 2-4, it is thought that as the volume of the embedded magnetic body is large, a defect such as a detachment of the ferromagnetic body is unlikely to occur during repeated use, the durability increases, and even the servo characteristics of the one hundred thousandth magnetic recording medium pass, even when r is less than 1 nm. Also, even when r is greater than 10 nm, or even when h₁ is less than 2 nm, it is thought that as the volume of the embedded magnetic body is large when the track pitch is more than 125 nm, as with samples 2-7, 2-8, 2-11, and 2-12, it is quite possible to obtain an amount of magnetization sufficient to reverse the magnetization of the transfer medium.

### Example 5

Furthermore, master substrates wherein the non-magnetic protective film 3 of the sample 1-8 of the Example 1 is of the materials shown in Table 4 are fabricated, and the effects of differences in the material of the non-magnetic protective film 3 are considered.

The formation of the non-magnetic protective film 3 of sample 3-1 is carried out by diluting a polyimide coating agent (TORAY Co., Ltd. Semicofine) to an appropriate density, and applying the agent to a thickness of 18 nm from the surface of the non-magnetic base 1 using a spin coating. Subsequently, an RIE using O₂ gas is carried out until h₂ is 3 nm.

The fabrication of sample 3-2 is carried out in the same way as in the Example 1.

The fabrication of sample 3-3 is carried out in the same way, except that a Hitachi Chemical HSG-225 is used as the SOG application agent in the Example 1.

With samples 3-4 and 3-5, a deposition is carried out to a thickness of 18 nm from the surface of the non-magnetic base 1 using a sputtering method that uses an aluminum target. When sputtering, the sputtering of 3-4 is carried out with a pure Ar gas, but the sputtering of 3-5 is carried out using an Ar gas including 1% O₂. Subsequently, an ion beam etching (IBE) is carried out until h₂ becomes 3 nm.

With samples 3-6 and 3-7, a deposition is carried out to a thickness of 18 nm from the surface of the non-magnetic base 1 using sputtering methods that use a Si target and a SiO₂ target respectively. The sputtering is carried out with a pure Ar gas. Subsequently, an RIE using CF₄ gas is carried out until h₂ becomes 3 nm.

With sample 3-8, a deposition is carried out to a thickness of 18 nm from the surface of the non-magnetic base 1 using a sputtering method that uses a carbon target. The sputtering is carried out with a pure Ar gas. Subsequently, an RIE using O₂ gas is carried out until h₂ becomes 3 nm.

Also, the hardness of each kind of material is measured using a thin film hardness measuring device (nanoindenter: Agilent Technologies product, model number Nano Indenter G200). A sample with a film thickness of 200 nm, fabricated using a method the same as that heretofore described, is prepared, and the thin film hardness is measured from the indentation amount and indentation force of the nanoindenter.

A magnetic transfer and servo characteristic evaluation are carried out, using the master substrates fabricated as heretofore described, in the same way as in the Example 1. However, two kinds of magnetic transfer repetition are carried out; one wherein cleaning of the surface of the master substrate is carried out by wiping with a tape every 1,000 times, and one wherein absolutely no cleaning of the master substrate is carried out until the one hundred thousandth magnetic transfer.

The results are shown in Table 4.

TABLE 4
Table 4. Servo Characteristic Evaluation Results for Each Kind of Sample

| | | | Servo Characteristics | Servo Characteristics |
|---|---|---|---|---|
| | | | of Magnetic | of Magnetic |
| | | Hardness of | Recording Medium: | Recording Medium: |
| | | Non-magnetic | After One Hundred | After One Hundred |
| Sample | Non-magnetic Protective Film | Protective | Thousandth transfer | Thousandth transfer |
| Number | Material | Film | with Cleaning | without Cleaning |
| 3-1 | Polyimide | 0.3 GPa | Pass | Pass |
| 3-2 | SOG (Tokyo Ohka Kogyo OCNL505) | 0.8 GPa | Pass | Pass |
| 3-3 | SOG (Hitachi Kasei HSG-225 | 1.3 GPa | Pass | Fail |
| 3-4 | Aluminum (sputter film) | 0.5 GPa | Pass | Pass |
| 3-5 | Aluminum (sputter film in O₂ gas) | 1.5 GPa | Pass | Fail |
| 3-6 | SiO₂ (sputter film) | 4 GPa | Pass | Fail |
| 3-7 | Si (sputter film) | 5 GPa | Pass | Fail |
| 3-8 | Carbon (sputter film) | 9 GPa | Pass | Fail |

According to the results in Table 4, whatever material is used for the non-magnetic protective film 3, the servo characteristics of the one hundred thousandth magnetic recording medium are sufficient when there is cleaning. Furthermore, when the non-magnetic protective film 3 is of a hardness of 1 GPa or less, the servo characteristics of the one hundred thousandth magnetic recording medium can pass, even without cleaning the master substrate by wiping with a tape. It is thought that this is because, when using a material with a hardness of 1 GPa or less as the non-magnetic protective film material, even when microscopic particles become mixed in between the master substrate and magnetic transfer medium during the magnetic transfer, the particles are trapped in the non-magnetic protective film, meaning that there is no effect on the adherence between the surfaces of the master substrate and magnetic recording medium.

What is claimed is:

1. A magnetic transfer master substrate having a ferromagnetic body pattern corresponding to an information signal array, for transferring an information signal therein to a magnetic recording medium, the substrate comprising:
a non-magnetic base having depressed portions formed on a surface thereof corresponding to the information signal array;
a ferromagnetic body formed in the depressed portions, and having a top portion thereof protruding above the surface of the non-magnetic base; and
a non-magnetic protective film covering the surface of the non-magnetic base, except for the depressed portion thereof, and also covering aside portion of the ferromagnetic body, wherein
a section through the top portion of the ferromagnetic body, taken perpendicularly to the substrate, includes a round corner, a curvature of which has a radius of no less than 1 nm and no more than 10 nm, and
an apex of the top portion of the ferromagnetic body protrudes above the surface of the non-magnetic base by 2 nm or more, and protrudes above the surface of the non-magnetic protective film by a distance less than the radius of the curvature.

2. A method of manufacturing a magnetic transfer master substrate having a ferromagnetic body pattern corresponding to an information signal array, for transferring an information signal thereinto a magnetic recording medium, the method comprising:
providing a non-magnetic base;
forming depressed portions, corresponding to the information signal array, in a surface of the non-magnetic base;
depositing a ferromagnetic body in the depressed portions and on the surface of the non-magnetic base;
etch-processing the non-magnetic base and the ferromagnetic body, using a smaller etching rate for the ferromagnetic body than for the non-magnetic base, to thereby form the ferromagnetic body pattern, wherein
the ferromagnetic body protrudes above the surface of the non-magnetic base to a height of 2 nm or more, and
a section through the ferromagnetic body, taken perpendicularly to the substrate, includes a round corner, a curvature of which has a radius of no less than 1 nm and no more than 10 nm; and
covering both the surface of the non-magnetic base except for the depressed portion thereof, and a portion of the ferromagnetic body, with a non-magnetic protective film, such that a distance from the surface of the non-magnetic protective film to an apex of the ferromagnetic body is less than the radius of said curvature.

3. The magnetic transfer master substrate according to claim 1, wherein the non-magnetic protective film is of a hardness of 1 GPa or less.

4. A magnetic transfer method for transferring an information signal, from a master substrate having a ferromagnetic body pattern corresponding to an information signal array, to a magnetic recording medium, the master substrate including:
a non-magnetic base having depressed portions formed on a surface thereof corresponding to the information signal array;
a ferromagnetic body formed in the depressed portions, and having a top portion protruding above the surface of the non-magnetic base; and
a non-magnetic protective film covering the surface of the non-magnetic base, except for the depressed portion thereof, and covering a side portion of the ferromagnetic body, wherein
a section through the top portion of the ferromagnetic body, taken perpendicularly to the substrate, includes a round corner, a curvature of which has a radius of no less than 1 nm and no more than 10 nm, and
an apex of the top portion of the ferromagnetic body protrudes above the surface of the non-magnetic base by 2 nm or more, and protrudes above the surface of the non-magnetic protective film by a distance less than the radius of the curvature,
the method comprising:
bringing the master substrate and the magnetic recording medium into contact, one on top of the other;
applying a magnetic field to the contacting master substrate and magnetic recording medium, and recording a magnetization pattern corresponding to the ferromagnetic body pattern of the master substrate on the magnetic recording medium; and
separating the master substrate and the magnetic recording medium.
